(19) United States
(12) Patent Application Publication
(10) Pub. No.: US 2003/0213268 A1
(43) Pub. Date: Nov. 20, 2003

(54) Process for solution-doping of optical fiber preforms

(76) Inventor: Daniel Scott Homa, Baltimore, MD (US)

Correspondence Address: ROPES & GRAY LLP, ONE INTERNATIONAL PLACE, BOSTON, MA, 02110-2624, US

(21) Appl. No.: 10/213,830

(22) Filed: Aug. 6, 2002

Related U.S. Application Data
(60) Provisional application No. 60/381,695, filed on May 20, 2002.

(51) Int. Cl. C03B 37/018

(52) U.S. Cl. 65/390; 65/399; 65/419

(57) ABSTRACT

A method for producing an optical fiber preform is disclosed. The fiber core is solution-doped with a high dopant concentration of an index modifier, preferably aluminum. High aluminum concentrations can be achieved without incorporating phosphorus in the core.

### CROSS-REFERENCE TO OTHER PATENT APPLICATIONS

This application claims the benefit of U.S. provisional Application No. 60/381,695, filed May 20, 2002, the subject matter is incorporated herein by reference in its entirety.

### FIELD OF THE INVENTION

The present invention is directed to the manufacture of preforms for optical fibers, and more particularly to solution-doping the preform core with a high concentration of an index modifying dopant.

### BACKGROUND OF THE INVENTION

Rare earth doped fibers have received considerable attention as they are suitable for a wide range of applications, such as passive optical waveguides for short and long haul data transmission as well as fiber-based sources and optical amplifiers. The fibers are typically made of silica glass and include a core and a cladding, with the core having an index of refraction higher than that of the cladding. To change the index of refraction of the glass, dopants are included during manufacture which lower or raise the index of refraction. Index-raising dopants, which are the most widely used dopants, include Al, Ge, P, Zr and Ti, whereas fluorine and boron are index-lowering dopants. Other dopants considered for use in optical fibers include Nb, Ta, Ga, In, Sn, Sb, Bi, the 4f rare earths (atomic numbers 57-71), and the alkaline earths Be, Mg, Ca, Zn, Sr, Cd, and Ba, which also modify the refractive index. Other materials, such as Hf, Pd, Ag, Zn, Pb, Ga, In, Sn, Sb, As, Li, Na, K, Rb, and Cs can also be incorporated as index modifiers and/or to modify other physical properties of oxides glasses, such as the thermal expansion coefficient, glass transition temperature, photosensitivity, etc. The addition of alkali/alkaline earth metals make it possible to homogeneously dope large amounts of rare earth elements in silica glass without significantly altering the phonon energy. Advantageously, the gain curve of an Er-doped fiber can be flattened by introducing co-dopants, such as Al, yielding a higher bandwidth of an Er-doped fiber amplifier. The co-dopants can also reduce clustering of rare-earth atoms in the glass matrix and thereby increase the conversion efficiency of the amplification process by reducing non-radiative recombination.

To achieve the aforedescribed improved properties, however, a high doping level of the co-dopants, in particular aluminum, is typically required which has proven difficult in practice when using traditional doping techniques, such as solution doping, in particular when preparing a glass that is substantially free of phosphorus.

AlCl₃ is a suitable starting material for the incorporation of Al₂O₃ in the core of the fiber preform, since it can be obtained in high purity and is highly soluble. However, to prevent phase-separation of the alumina-silicate glass at higher Al concentrations, P₂O₅ is typically incorporated in the unfused core layer. Al₂O₃ dopant levels up to 8.5 mol % have been reported in phosphorous co-doped glass. However, phosphorous co-doping has several disadvantages. The saturated vapor pressure of P₂O₅ at the collapse temperature of the fiber preform is very high, causing evaporation of phosphorus and the formation of bubbles. This also makes it more difficult to control the radial composition of the core glass and depresses the refractive index in the center of the preform and hence also in the fiber core.

Furthermore, the first harmonic of the P-OH vibration is in the wavelength range of ˜1.6 μm and thus increases the background loss at that wavelength. The bonding energy of P-OH is also close to the I_{13/2} metastable state of Er³⁺ and may cause quenching of the fluorescence.

It would therefore be desirable to provide a process which incorporates high levels of index-modifying dopants into silica glass without clustering and with a high radial and longitudinal uniformity.

### SUMMARY OF THE INVENTION

The invention is directed to the manufacture of a fiber preform using a modified chemical vapor deposition (MCVD) process in combination with solution doping.

According to one aspect of the invention, a method for producing an optical fiber preform includes depositing one or more cladding layers on an inside surface of a substrate tube, depositing a porous soot on an interior surface of the one or more cladding layers, and filling an interior volume of the tube with a solution that includes at least one soluble index modifier. The tube with the solution is then cooled to a predetermined temperature, and the porous soot is impregnated with the cooled solution for a predetermined time. The solution is then drained from the tube and a flow of an inert gas is established through the tube at a predetermined flow rate while simultaneously at least rotating the tube about a longitudinal axis. The tube is then collapsed to form the preform.

According to another aspect of the invention, in particular when a high dopant concentration is desired while less stringent requirements are placed on the dopant incorporation uniformity in the longitudinal direction of the preform, the method can be simplified and includes depositing one or more cladding layers on an inside surface of a substrate tube, depositing a porous soot on an interior surface of the one or more cladding layers, filling an interior volume of the tube with a solution that includes at least one soluble index modifier, and cooling the tube with the solution to a predetermined temperature, impregnating the porous soot with the cooled solution for a predetermined time, draining the solution from the tube, drying the porous soot by flowing an inert gas through the tube at a predetermined flow rate; and collapsing the tube to form the preform.

Embodiments of the invention may include one or more of the following features. The predetermined temperature of the solution that includes the soluble index modifier can be below room temperature, i.e., between below the freezing point of the solution, e.g., −183° C., and approximately 20° C. Drying the impregnated surface may include orienting the tube in a substantially vertical orientation; rotating the tube; and periodically flipping the tube at predetermined time intervals perpendicular to the longitudinal axis.

To maintain the uniformity of the dopant concentration in the longitudinal direction of the preform, the predetermined flow rate for drying the tube can be between 0.1 m/sec and 1.5 m/sec. A rotation speed of the tube in the range of between 5-200 rpm, preferably approximately 30 rpm, can be selected. The tube can be flipped every 0.5 to 10 minutes.

To produce optical fiber based devices, such as amplifiers and lasers, the interior porous surface can be impregnated with a solution that also includes a rare-earth element compound, which can occur either before or at the same time the solution that includes the at least a soluble index modifier is filled into the tube.

The method is particularly effective over conventional doping methods when the soot is substantially free of phosphorus. When the soluble index modifier includes aluminum, a concentration of aluminum in the preform of greater than approximately 10 mol % can be achieved, providing a difference in the refractive index between a core section of the preform and the cladding layer of greater than approximately 0.025.

An optical fiber can be drawn from the preform in a conventional manner.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 is a schematic process flow for fabricating a fiber preform according to an exemplary embodiment;

FIG. 2 shows a radial concentration profile of an exemplary preform having a solution-doped P-free core; and

FIG. 3 shows a radial refractive index profile of the preform of FIG. 2; and

FIG. 4 shows the erbium gain profile along the length of the preform.

### DETAILED DESCRIPTION OF CERTAIN ILLUSTRATED EMBODIMENTS

The method described herein is directed to the manufacture of a fiber preform using a modified chemical vapor deposition (MCVD) process, wherein the core of the fiber preform is doped with an index modifier by solution doping. In particular, the method described herein can incorporate in excess of 12 mol % Al₂O₃, which raises the refractive index difference between the core and the cladding by more than 0.03.

In MCVD, chloride reagent gases such as SiCl₄ and GeCl₄ react homogeneously with oxygen inside a rotating glass tube, e.g., a fused quartz tube. The reaction produced by heating with an external torch produces silica particles that deposit thermo-phoretically on the inner wall of the tube to form a thin, porous layer. Each layer is vitrified by sintering it with heat from the same torch as it travels along the tube. The cladding material is deposited first, and then the core material. After the deposition steps are completed, the tube is collapsed to make the preform.

Optical fiber preforms made by the MCVD method can be doped by volatilizing and entraining dopant material, for example AlCl₃, in a heated carrier gas such as helium, and adding the resulting gaseous mixture to the reactant gases within the fused quartz tube. However, this approach tends to produce a dopant concentration gradient along the axis of the tube, which is difficult to suppress. Alternatively, the desired dopants can be incorporated in the porous soot created by the MCVD processes by solution doping. MCVD preforms are only partially sintered prior to immersion of the tube in a solution containing the dopant material, which is absorbed into the pores of the soot. The tube with the solution-doped porous layer is then dried, dehydrated in chlorine at about 1000° C. to remove OH, and sintered to a solid preform.

Traditional solution doping methods are prone to the formation of clusters and microcrystallites of dopant material. Microcrystallites are undesirable because they can scatter light, whereas clusters are undesirable because they absorb light. Moreover, when the solution evaporates, it leaves behind a residue containing the starting species, e.g., ErCl₃.6H₂O or erbium oxychloride, to which the chloride is converted upon heating. Accordingly, special measures have to be taken for effectively and homogeneously incorporating dopants into substantially P-free silica glass by solution doping.

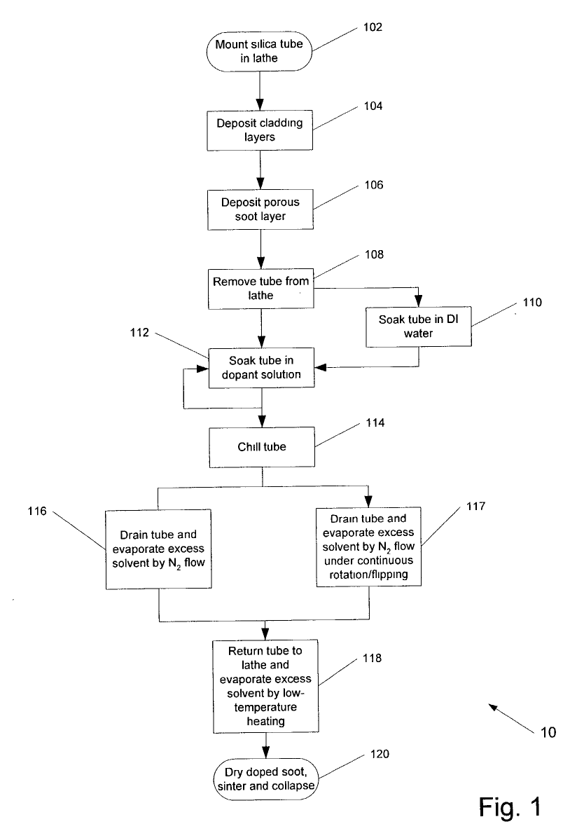

FIG. 1 is a schematic flow diagram illustrating an exemplary process 10 according to the invention for fabricating solution-doped fiber preforms with a high dopant concentration in the core, that do not require addition of phosphorus to the core. In step 102, a silica tube in mounted in a lathe and cladding layers, which may contain phosphorus. Thereafter, a porous soot layer is deposited which may be doped with Ge, step 106, whereafter the tube is removed from the lathe, step 108. After an optional presoak in deionized (DI) water, step 110, the tube is soaked with the dopant solution which impregnates the soot layer, step 112. Different dopant can be either incorporated simultaneously in the dopant solutions, or different dopant solutions can be applied to the soot layer sequentially, possibly at different temperatures and soak times. Thereafter, the tube is chilled for a specified time, step 114, and drained.

In an alternative embodiment (not shown in the flow chart of FIG. 1), the tube can be filled with the dopant solution, which can be heated to increase the solubility of the dopant in solution, at ambient temperature or above to impregnate the soot layer, whereafter the solution is drained and the tube with the impregnated soot layer cooled to a predetermined temperature below ambient temperature.

Lowering the temperature of the solution or of the tube with the impregnated soot layer, in particular when using AlCl₃, has two important effects. First, the solubility of the soluent is reduced, causing more AlCl₃ to precipitate out of solution which increases the quantity of Al able to crystallize at nucleation sites in the pores and at the surface of the soot. Second, the viscosity increases, allowing more of the AlCl₃ solution to remain on the inner wall of the preform tube after the solution is drained. We can assume that the more homogeneous AlCl₃ distribution results from the increased number of nucleation sites and the reduced crystal growth rate at lower temperature.

Excess solvent is evaporated under a low gas flow, for example, a nitrogen gas flow, step 116. The inert gas can be heated to promote drying. The low nitrogen flow rate does not disturb the uniformity of the remaining solution and therefore favorably contributes to the doping uniformity in the radial and longitudinal directions of the tube. If an improved doping uniformity is desired, the tube can in addition at least be continuously rotated, but preferably also repeatedly flipped to prevent accumulation of any remaining dopant solution, step 117. Rotating the tube about its longitudinal axis and flipping the tube perpendicular to the longitudinal axis, as well as randomly changing its near-vertical orientation prevents localized pooling of any remaining unevaporated solution in the tube which could otherwise cause doping nonuniformity. Alternatively, the tube can also be rotated at a significantly greater rotation rate if the flipping step is omitted. It should be mentioned that the drying technique, which includes at least rotation, but preferably also flipping the tube, at a low flow of N₂ promotes the high doping uniformity in the preforms. A low N₂ flow rate with a flow velocity of between 0.1 m/sec and 5 m/sec, preferably between approximately 0.5 m/sec and 1.5 m/sec, is selected. Other inert gases besides N₂ can be used, such as He or Ar.

The soot is then allowed to dry for an extended period of time with a low flow of an inert gas. Although less efficient, it is also possible to let the soot dry in air for an extended period of time. The solution can be considered to be dry when the soot changes from a clear appearance to a slush-like color and consistency, which indicates that the remaining solvent has evaporated and the AlCl₃ has precipitated out of solution and crystallized as aluminum hydrate inside and on the walls of the soot. Thereafter, the tube is returned to the lathe and any excess solvent is removed slowly by moderate heat, using, for example, a hand-held torch, step 118. Furthermore, the soot is then dried under a Cl₂—O₂ atmosphere to reduce the OH-ion impurities in soot.

As in conventional processes, the fabrication process 10 is completed by sintering the now dry soot and collapsing the tube, step 120. The optical fiber can then been drawn using conventional fiber manufacturing techniques.

Solution-doping of a fiber preform core will now be described with reference to the following three examples.

### EXAMPLE 1

The first example relates to Al-solution-doping the core of a fiber preform having a phosphorus-doped cladding and a germanium-silicate core. Er was introduced as a core dopant by aerosol deposition. It should be noted, however, that unlike with conventional processes described above, phosphorous is not incorporated in the Al—Er doped core. A 10 mm×14 mm quartz tube [Heraeus Tenevo F300 fused silica] was mounted in the lathe. The tube was etched with a flow of SiF₄, and 12 phosphorus doped cladding layers were deposited by MCVD. A germanium-doped core glass layer was deposited with gas flow rates of 150 ml/min for SiCl₄, 50 ml/min for GeCl₄, 500 ml/min for O₂, and 400 ml/min for He at a temperature of 1975° C. A germanium doped porous soot layer was then deposited with gas flow rates of 130 ml/min for SiCl₄, 40 ml/min for GeCl4, 500 ml/min for O₂, and 400 ml/min for He at temperature of 1630° C. The deposition temperature was optimized as to achieve the highest porosity while retaining enough adherence to the quartz tube wall so that the soot would not break off during subsequent processing steps. The substrate tube and handle tube (as one piece) were removed from the lathe and the soot was soaked in deionized water for approximately one hour. The deionized water was then drained from the tube, and filled with a saturated solution of >450 g AlCl₃.6H₂O dissolved in 600 g deionized water. The soot soaked for approximately 30 min, whereafter the tube was cooled to a temperature of approximately 0° C. by surrounding the tube with ice. The tube was then allowed to soak for another hour. The solution was then drained, and a low nitrogen flow of approximately 10 l/min, corresponding to a linear flow velocity of approximately 1 m/sec, was introduced into the tube to enhance the evaporation of any excess solvent. During the evaporation process, the tube was oriented substantially vertically and rotated about its longitudinal axis at a speed of approximately 30 rpm and flipped perpendicular to the longitudinal axis approximately every 2 minutes in attempt to prevent any localized pooling of the solution. The evaporation procedure was done till completion, which was approximately 1 hour. Thereafter, the soot was allowed to dry overnight under flow low flow of nitrogen, 5 l/min, to remove any excess solvent. The tube was then returned to the lathe and heated with a hand torch to evaporate any excess water. An erbium-doped aerosol was then deposited on the doped soot at a temperature of 1250° C. and at flow rates of 500 m/min O₂ and 250 ml/min He. The Er-doped aerosol was deposited in 10 passes at a speed of 20 mm/min to achieve adequate uniformity along the length of the preform. The composition of the aerosol was 1.5 g ErCl₃.6H₂O, 11 g AlCl₃.6H₂O, and 35 g deionized water. The doped soot was then dried for approximately one hour at flow rates of 200 ml/min Cl₂, 300 ml/min O₂, and 300 ml/min He. This was performed to reduce the absorption peak at 1385 nm due to the second O—H harmonic. The doped soot was then sintered at a temperature of 2100° C. in the forward direction at a torch speed of 20 mm/min, whereafter the tube was collapsed immediately in the reverse direction to alleviate any stress fractures caused by a thermal mismatch between localized regions of high aluminum concentration in the silica glass.

### EXAMPLE 2

The second example relates to Al- and Er-solution-doping the core of a fiber preform having a phosphorus-doped cladding and a germanium-silicate core. Er was introduced in the core also by solution doping. In this example, phosphorous is also not incorporated in the Al—Er doped core. A 10 mm×14 mm quartz tube [Heraues Tenevo F300 fused silica] was mounted in the lathe. The tube was etched with a flow of SiF₄, and 12 phosphorus-doped cladding layers were deposited by MCVD. A germanium-doped core glass layer was deposited at gas flow rates of 150 ml/min SiCl₄, 50 ml/min GeCl₄, 500 ml/min O₂, and 400 ml/min He at a temperature of 1975° C. A germanium-doped porous soot layer was then deposited at gas flow rates of 130 ml/min for SiCl₄, 40 ml/min for GeCl₄, 500 ml/min for O₂, and 400 ml/min for He at a temperature of 1630° C. The deposition temperature was optimized as to achieve the highest porosity while retaining enough adherence to the quartz tube wall so that the soot would not break off during subsequent processing steps. The substrate tube and handle tube (as one piece) were removed from the lathe and the soot was soaked for approximately one hour in an erbium-doped solution consisting of 20.7 g ErCl₃.6H₂O and 600 g deionized water. The erbium-doped solution was drained from the tube, and the tube was filled with a saturated solution of aluminum chloride consisting >450 g of AlCl₃.6H₂O dissolved in 600 g deionized water. The soot soaked for approximately 30 min, whereafter the tube was cooled in ice to a temperature of approximately 0° C. and allowed to soak for 1 hour. The solution was then drained, and a low nitrogen flow of approximately 10 l/min was introduced into the tube to accelerate the evaporation of any excess solvent. During the evaporation process, the tube was oriented substantially vertically and rotated about its longitudinal axis at a speed of approximately 30 rpm and flipped perpendicular to the longitudinal axis approximately every 2 minutes in attempt to prevent any localized pooling of the solution. The evaporation procedure was done until evaporation was complete, which was approximately 1 hour. Thereafter, the soot was allowed to dry overnight under flow low flow of nitrogen, 5 l/min, to remove any excess solvent. The tube was then returned to the lathe and heated with a hand torch to evaporate any excess water. The doped soot was then dried for approximately one hour with flow rates of 200 ml/min for Cl₂, 300 ml/min for O₂, and 300 ml/min for He. This was performed to reduce the absorption peak at 1385 nm due to the second O—H harmonic. The doped soot was then sintered at temperature of 2100° C. in the forward direction at a torch speed of 20 mm/min and the tube immediately collapsed in the reverse direction.

### EXAMPLE 3

The third example relates to solution-doping the core of a fiber preform having a phosphorus-free cladding and a silicate core. In this example, unlike the second example where the two exemplary dopants were introduced in the core sequentially, Al was here co-doped simultaneously with another dopant. A 19 mm×25 mm quartz tube [Heraeus Tenevo F300 fused silica] was mounted in the lathe. The tube was etched in a flow of SiF₄, and 4 silica cladding layers were deposited by MCVD. A porous soot layer was then deposited at gas flow rates of 130 ml/min for SiCl₄, 1000 ml/min for O₂, and 400 ml/min for He at temperature of 1630° C. The deposition temperature was optimized to achieve the highest porosity but retaining enough adherence to the quartz tube wall so that the soot would not break off during subsequent processing steps. The substrate tube and handle tube (as one piece) were removed from the lathe and the soot was soaked in deionized water for approximately one hour. Thereafter, the deionized water was drained from the tube, and the tube was filled with a saturated solution of magnesium chloride with >336 g of MgCl₃ and 200 g AlCl₃.6H₂O dissolved in 600 g of deionized water. The soot soaked for approximately 30 min, whereafter the tube was cooled in ice to a temperature of approximately 0° C. and allowed to soak for 1 hour. The solution was then drained, and a low nitrogen flow of approximately 10 l/min was introduced into the tube to accelerate the evaporation of any excess solvent. During the evaporation process, the tube was oriented substantially vertically and rotated about its longitudinal axis at a speed of approximately 30 rpm and flipped perpendicular to the longitudinal axis approximately every 2 minutes in attempt to prevent any localized pooling of the solution. The evaporation procedure was done until evaporation was complete, which was approximately 1 hour. The tube was then returned to the lathe and heated with a hand torch to evaporate any excess water. The doped soot was then dried for approximately one hour with flow rates of 200 ml/min for Cl₂, 300 ml/min for O₂, and 300 ml/min for He. This was performed to reduce the absorption peak at 1385 nm due to the second O—H harmonic. The doped soot was then sintered at temperature of 2100° C. in the forward direction at a torch speed of 20 mm/min and the tube immediately collapsed in the reverse direction.

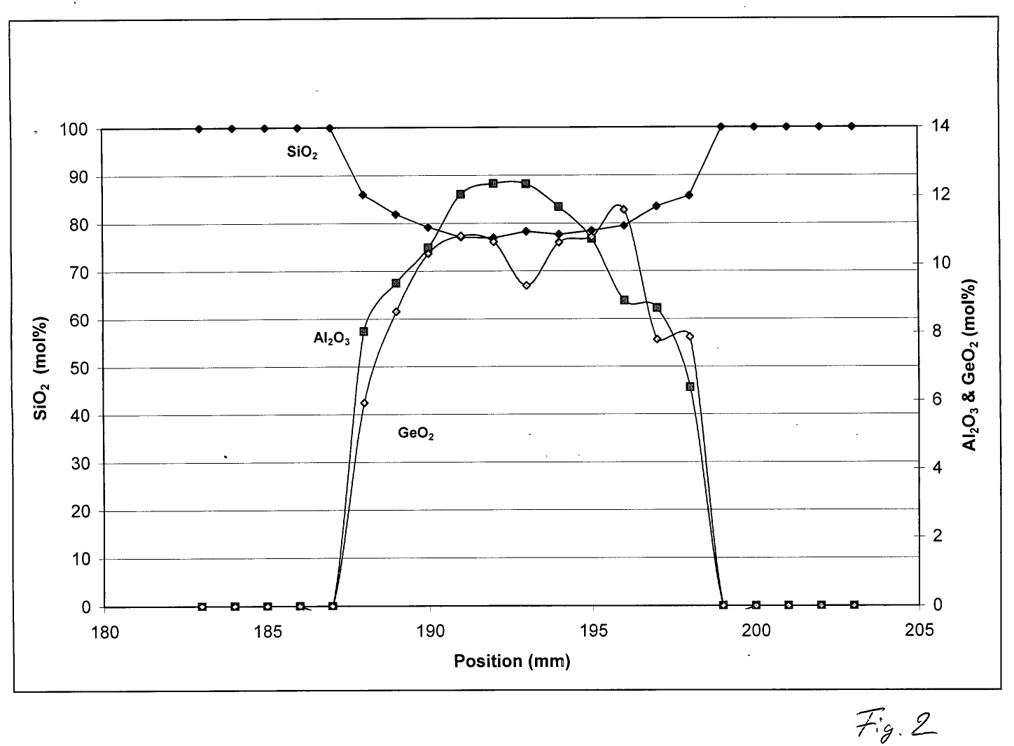

FIG. 2 shows the relative molar concentration, as measured by Electron Probe Microanalysis (EPMA), of SiO₂, GeO₂ and Al₂O₃ (in mol %) across a radial cross-section of an exemplary preform produced by the method described in example 2. The concentration of Al₂O₃ is in excess of 12 mol % which is 50% higher than that reported by Poole (Proc. ECOC 1888) and almost twice as large as that of an Al₂O₃/P₂O₅/SiO₂ core matrix reported by Mat\check{e}jek et al. (Ceramics—Silikaty Vol. 45 (2), pages 62-69 (2001)).

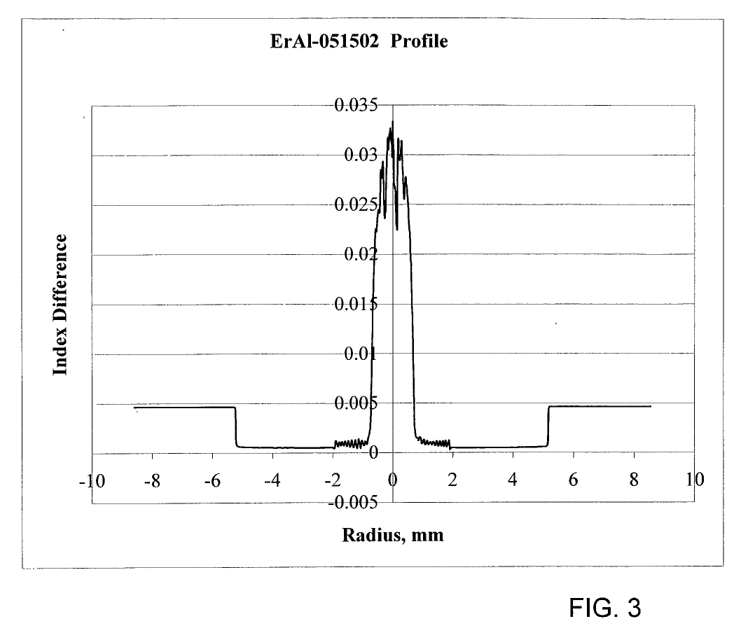

FIG. 3 shows the difference An in the refractive index between the core and the cladding of a preform prepared by the method of example 2 described above. An is approximately 0.03 in the center, and An values as high as 0.04 were observed in a preform prepared by the method described in example 1 above. Values reported in the literature (U.S. Pat. No. 5,282,079 and Vienne et al., J. Lightwave Technology, Vol. 16, No. 1, November 1998, pages 1990-2001) range from 0.012 to 0.016 and tend to exhibit a dip in the center of the core. No such pronounced dip was observed in preforms produced with the method of the invention.

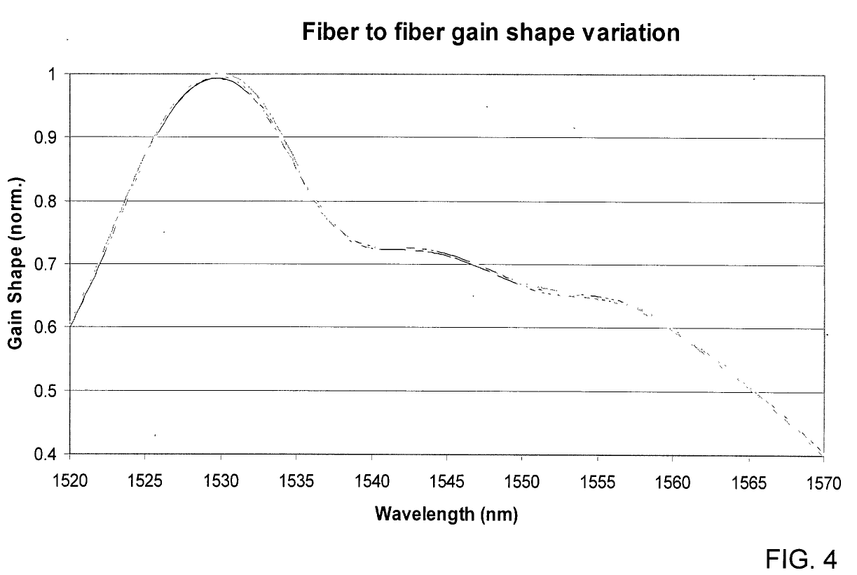

FIG. 4 shows the variation in the shape of the optical gain of Er-doped fibers drawn from the preforms produced with the method of the invention that included rotation and flipping of the tube during the drying process. The relative flatness of the gain profile indicates an efficient Al incorporation in the preform, and the lack if discernable variation in the gain from fiber to fiber is a manifestation of the doping uniformity in the longitudinal direction of the preform that can be achieved with the method of the invention.

In summary, a doped optical fiber preform with properties comparable to those obtained with vapor-phase processes can be fabricated with the disclosed solution doping method. The disclosed method reduces manufacturing cost by using less complex equipment and can be used with a wider range of dopants, as no volatile dopant materials are required.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for producing an optical fiber preform, comprising:
depositing one or more cladding layers on an inside surface of a substrate tube;
depositing a porous soot on an interior surface of the one or more cladding layers;
filling an interior volume of said tube with a solution that includes at least a soluble index modifier, and cooling said tube with said solution to a predetermined temperature;
impregnating said porous soot with said cooled solution for a predetermined time, draining said solution from the tube;
drying said impregnated porous soot by flowing an inert gas through said tube at a predetermined flow rate while simultaneously at least rotating said tube with a predetermined rotation speed about a longitudinal axis; and
collapsing said tube to form the preform.

2. The method of claim 1, wherein said predetermined temperature is between approximately −183° C. and approximately +20° C.

3. The method of claim 1, wherein said predetermined temperature is between approximately −10° C. and approximately +10° C.

4. The method of claim 1, wherein drying said impregnated surface further includes
orienting said tube in a substantially vertical orientation; and
periodically flipping said tube at predetermined time intervals perpendicular to the longitudinal axis.

5. The method of claim 1, wherein said soluble index modifier comprises at least one compound selected from the group consisting of Al, Zr, Hf, Nb, Ta, Pd, Ag, Cd, Zn, Pb, Ga, In, Sn, Sb, Bi, In, P, As, Li, Na, K, Rb, Cs, Be, Mg, Ca, Sr, and Ba.

6. The method of claim 1, wherein said predetermined flow rate is between 0.1 m/sec and 1.5 m/sec.

7. The method of claim 1, wherein said predetermined rotation speed of said tube is in range between 5-200 rpm.

8. The method of claim 1, wherein said predetermined rotation speed of said tube is approximately 30 rpm.

9. The method of claim 4, wherein said predetermined time interval is between 0.5 minutes and 10 minutes.

10. The method of claim 1, further comprising impregnating said interior porous surface with a solution comprising a rare-earth element compound.

11. The method of claim 10, wherein said impregnating with a rare-earth element compound is carried out before said filling with the solution that includes the at least one soluble index modifier.

12. The method of claim 10, wherein said impregnating with a rare-earth element compound is carried out simultaneously with said filling with the solution that includes the at least one soluble index modifier.

13. The method of claim 1, wherein said soot is substantially free of phosphorus.

14. The method of claim 1, wherein said soluble index modifier comprises aluminum and a concentration of aluminum in the preform is greater than approximately 10 mol %.

15. The method of claim 1, wherein said soluble index modifier comprises aluminum and a difference in a refractive index between a core section of the preform and a cladding layer is greater than approximately 0.025.

16. The method of claim 1, further comprising drawing the optical fiber from the preform.

17. A method for producing an optical fiber preform, comprising:
depositing one or more cladding layers on an inside surface of a substrate tube;
depositing a porous soot on an interior surface of the one or more cladding layers;
filling an interior volume of said tube with a solution that includes at least a soluble index modifier, and cooling said tube with said solution to a predetermined temperature;
impregnating said porous soot with said cooled solution for a predetermined time;
draining said solution from the tube;
drying said porous soot by flowing an inert gas through said tube at a predetermined flow rate; and
collapsing said tube to form the preform.

18. The method of claim 17, wherein said predetermined temperature is between approximately −183° C. and approximately +20° C.

19. The method of claim 17, wherein said predetermined temperature is between approximately −10° C. and approximately +10° C.

20. The method of claim 17, wherein said inert gas flowing through said tube is heated.

21. A method for producing an optical fiber preform, comprising:
depositing one or more cladding layers on an inside surface of a substrate tube;
depositing a porous soot on an interior surface of the one or more cladding layers;
filling an interior volume of said tube with a solution that includes at least a soluble index modifier;
impregnating said porous soot with said solution for a predetermined time;
draining said solution from the tube;
cooling said drained tube with said impregnated porous soot to a predetermined temperature;
drying said impregnated porous soot by flowing an inert gas through said tube at a predetermined flow rate while simultaneously at least rotating said tube with a predetermined rotation speed about a longitudinal axis; and
collapsing said tube to form the preform.

22. The method of claim 21, further including heating the solution to a temperature between approximately 25° C. and a boiling point of the solution before filling the interior volume of said tube with the solution.

23. The method of claim 21, wherein said predetermined temperature is between approximately −183° C. and approximately +20° C.

24. The method of claim 21, wherein said predetermined temperature is between approximately −10° C. and approximately +10° C.

25. The method of claim 21, wherein drying said impregnated surface includes
orienting said tube in a substantially vertical orientation; and
periodically flipping said tube at predetermined time intervals perpendicular to the longitudinal axis.
